(19) United States
(12) Patent Application Publication
(10) Pub. No.: US 2026/0309115 A1
(43) Pub. Date: Oct. 8, 2026

(54) RECONFIGURABLE TURBINE FOR GEOTHERMAL ENERGY PRODUCTION

(71) Applicant: Sage Geosystems Inc., Houston, TX (US)

(72) Inventors: Douglas SIMPKINS, Houston, TX (US); Nathan WEISS, Bellaire, TX (US); Cynthia D. TAFF, Kingwood, TX (US); Lev M. RING, Bellaire, TX (US); Robert Lance COOK, Houston, TX (US)

(21) Appl. No.: 19/473,961

(22) PCT Filed: Apr. 19, 2024
(86) PCT No.: PCT/US2024/025432

§ 371 Date: Oct. 9, 2025

Related U.S. Application Data
(60) Provisional application No. 63/497,674, filed on Apr. 21, 2023.

(51) Int. Cl. F03B 13/00

(52) U.S. Cl. CPC F03B 13/00; F05B 2230/80

(57) ABSTRACT

A turbine for use in a power system includes a first impeller having a first impeller configuration. The turbine is operated at a location of the power system to drive a generator to generate electricity. The turbine is configured such that the first impeller may be removed from the turbine and replaced by a second impeller while the turbine remains in situ at the location where the turbine had been operated. The second impeller has a second impeller configuration different from the first impeller configuration. The changing of the first impeller to the second impeller may be in response to thermal decline of a geothermal resource, ambient temperature variations, or a change in the fluid used to operate the turbine.

### CROSS-REFERENCE TO RELATED APPLICATIONS

This application is an International Patent Application under the Patent Cooperation Treaty and claims priority to and the benefit of U.S. Provisional Patent Application Ser. No. 63/497,674 filed Apr. 21, 2023 and titled Reconfigurable Turbine for Geothermal Energy Production, the disclosure of which is incorporated herein in its entirety by this reference.

### BACKGROUND

### Field

Embodiments of the present disclosure generally relate to turbines for use in power systems, such as geothermal power systems.

### Description of the Related Art

Geothermal energy is a type of renewable energy generated within the earth. A geothermal fluid (such as water, steam, brine, a refrigerant, or a hydrocarbon) is heated in a subterranean geological formation by the earth's natural internal temperature. The heated geothermal fluid is produced to the earth's surface, where the heat of the geothermal fluid is used to perform useful work, such as heating buildings or generating electricity. The now-cooled geothermal fluid is reinjected into the subterranean formation, reheated by the subterranean formation, then produced again to the earth's surface to perform useful work.

In some power systems, the geothermal fluid is flowed through a turbine, which drives a generator to generate electricity. In some power systems, the heat from geothermal fluid is used to provide power for a binary cycle power plant. A heat exchanger transfers heat from the geothermal fluid to a working fluid of the binary cycle power plant. In an example, operation of the binary cycle power plant is based on the Brayton Cycle, in which the heated working fluid passes through a turbine, which drives a generator. In another example, operation of the binary cycle power plant is based on the Organic Rankine Cycle, in which the heated working fluid passes through an expander, which drives a generator.

Exemplary working fluids include hydrocarbons and refrigerants that have boiling points lower than water. The working fluids are selected according to one or more criteria such as the temperature of the feed of geothermal fluid to the heat exchanger, and the ambient temperature at the binary cycle power plant. However, during the working life of a geothermal resource, the temperature of the geothermal fluid that is produced from the subterranean formation can change. In a phenomenon known as thermal decline, the temperature of geothermal fluid being produced from the subterranean formation decreases over time. Additionally, the ambient temperature at the earth's surface changes with the transition between daytime and nighttime operation, and from season to season.

Thermodynamic properties of geothermal fluids and working fluids differ from fluid to fluid. A geothermal fluid or a working fluid suited for use in a power system (such as including a binary cycle power plant) at one time may become less suitable over time due to the changing operating environment of the power system. Similarly, a different geothermal fluid or a different working fluid that is initially less suited for use in a power system at one time may become more suitable than the originally-selected working fluid.

Operation of a power system (such as including a binary cycle power plant) may be optimized by periodically changing the geothermal fluid or the working fluid. However, the equipment of a power system (e.g., including a binary cycle power plant), such as the turbine/expander, is typically designed for a particular fluid. Changing the geothermal fluid or the working fluid while retaining the turbine/expander may not realize the expected operational benefits. Equipment such as the turbine/expander is expensive, and changing this equipment can be costly and time-consuming. Furthermore, the power system is not operational while the equipment is being changed. Thus, it can be impracticable to change the working fluid daily, weekly, monthly, or even seasonally.

Thus, there is a need for improved apparatus and methods that facilitate rapid changing of a working fluid of a power system (such as including a binary cycle power plant), and facilitate the realization of efficiency gains at the power system when the geothermal fluid or the working fluid is changed.

### SUMMARY

The present disclosure generally relates to turbines for use in power systems, such as geothermal power systems. In one implementation, a method includes operating a turbine at a location in a power system, the turbine including a first impeller having a first impeller configuration. The method further includes removing the first impeller from the turbine while the turbine remains in situ at the location, and installing a second impeller in the turbine while the turbine remains in situ at the location. The second impeller has a second impeller configuration different from the first impeller configuration. The method further includes operating the turbine with the second impeller at the location.

In another implementation, a method includes operating a turbine at a location in a power system using a first fluid having a first composition. The turbine includes a first impeller having a first impeller configuration. The method further includes operating the turbine with the first impeller using a second fluid having a second composition different from the first composition. The method further includes removing the first impeller from the turbine while the turbine remains in situ at the location, and installing a second impeller in the turbine while the turbine remains in situ at the location. The second impeller has a second impeller configuration different from the first impeller configuration. The method further includes operating the turbine with the second impeller using the second fluid.

In another implementation, a method includes operating a turbine at a location in a power system using a first fluid having a first composition. The turbine includes a first impeller having a first impeller configuration. The method further includes removing the first impeller from the turbine while the turbine remains in situ at the location, and installing a second impeller in the turbine while the turbine remains in situ at the location. The second impeller has a second impeller configuration different from the first impeller configuration. The method further includes operating the turbine with the second impeller using the first fluid, and operating the turbine with the second impeller using a second fluid having a second composition different from the first composition.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a power system.

FIG. 2 schematically illustrates a cross-sectional view of a turbine that may be used in the power system of FIG. 1.

FIG. 3 schematically illustrates a cross-sectional view of an impeller that may be used in the turbine of FIG. 2.

FIG. 4 is a flow diagram of a method of operating a power system, such as the power system of FIG. 1.

FIG. 5 is a flow diagram of a method of operating a power system, such as the power system of FIG. 1.

FIG. 6 is a flow diagram of a method of operating a power system, such as the power system of FIG. 1.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns turbines for use in power systems, such as geothermal power systems.

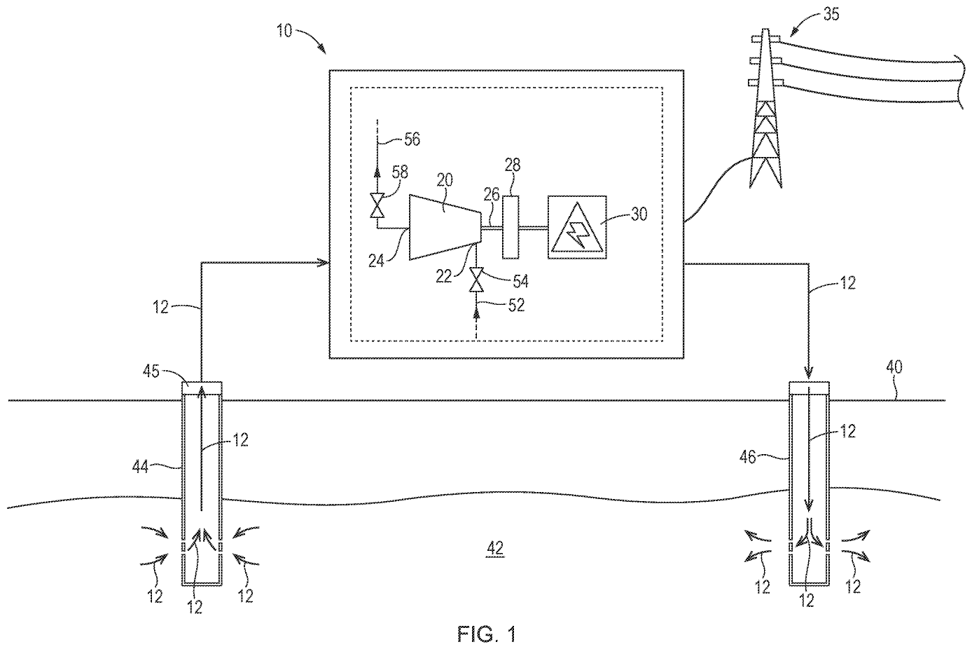

FIG. 1 schematically illustrates a power system 10. The power system 10 utilizes a power fluid (represented by arrows 12). The power fluid 12 may include any fluid (such as water, steam, brine, a refrigerant, a supercritical fluid, carbon dioxide, ammonia, an organic compound (e.g., a hydrocarbon, a fluorocarbon, etc.), or any combination thereof) that is injected into, or produced out of, a subterranean formation 42. In some embodiments, the power fluid 12 is a geothermal fluid. In some embodiments, the subterranean formation 42 is a geothermal subterranean formation.

The power fluid 12 may be heated, or may be maintained at an elevated temperature, by the subterranean formation 42. In an example, the temperature of the power fluid 12 is at or about 150 degrees C or higher, such as 175 degrees C or higher, 200 degrees C or higher, 250 degrees C or higher, or 300 degrees C or higher. The power fluid 12 is maintained at an elevated pressure in the subterranean formation 42. In an example, the pressure of the power fluid 12 in the subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the power fluid 12 is geopressured. In an example, the power fluid 12 may be a geopressured-geothermal fluid.

The power fluid 12 flows from the subterranean formation 42 into a first well 44, and flows up the first well 44 to a wellhead 45 at the earth's surface 40. The power fluid 102 flows from the wellhead 45 to the power system 10. As illustrated, in some embodiments, the power fluid 12 returns from the power system 10, and is injected back into the subterranean formation 42 via a second well 46. The power fluid 12 is heated by the subterranean formation 42, and then is produced back to the power system 10, and the cycle is repeated. In some embodiments, the power fluid 12 is produced from the subterranean formation via first well 44, and is injected back into the subterranean formation via the first well 44, and the cycle is repeated.

The power system 10 includes a turbine 20 which drives a shaft 26. The shaft 26 drives a generator 30, such as via a gearbox 28. The generator 30 generates electricity, which is routed to an electricity distribution network 35, such as a power grid.

The turbine 20 is installed at a location in the power system 10. An inlet 22 of the turbine is coupled to flowline 52 and valve 54. An outlet 24 of the turbine is coupled to flowline 56 and valve 58. The fluid that drives the turbine 20 flows through the flowline 52, into the inlet 22, through the turbine 20, then exits the turbine 20 at the outlet 24, and flows through the flowline 56. In some embodiments, the fluid that drives the turbine 20 is the power fluid 12. In some embodiments, the fluid that drives the turbine 20 is a working fluid of the power system 10. In an example, the turbine 20 is part of a binary cycle power plant of the power system 10. Exemplary working fluids include water, steam, brine, a refrigerant, a supercritical fluid, carbon dioxide, ammonia, an organic compound (e.g., a hydrocarbon, a fluorocarbon, etc.), or any combination thereof.

In some embodiments, the fluid flowing through the turbine 20 undergoes a phase change within the turbine 20. In an example, the fluid is in a liquid state (or in a supercritical state) at the inlet 22, and includes a vapor phase at the outlet 24. In some embodiments, the fluid flowing through the turbine 20 does not undergo a phase change within the turbine 20. In an example, the fluid is in a liquid state (or in a supercritical state) at the inlet 22, and remains in the liquid state (or in the supercritical state) at the outlet 24.

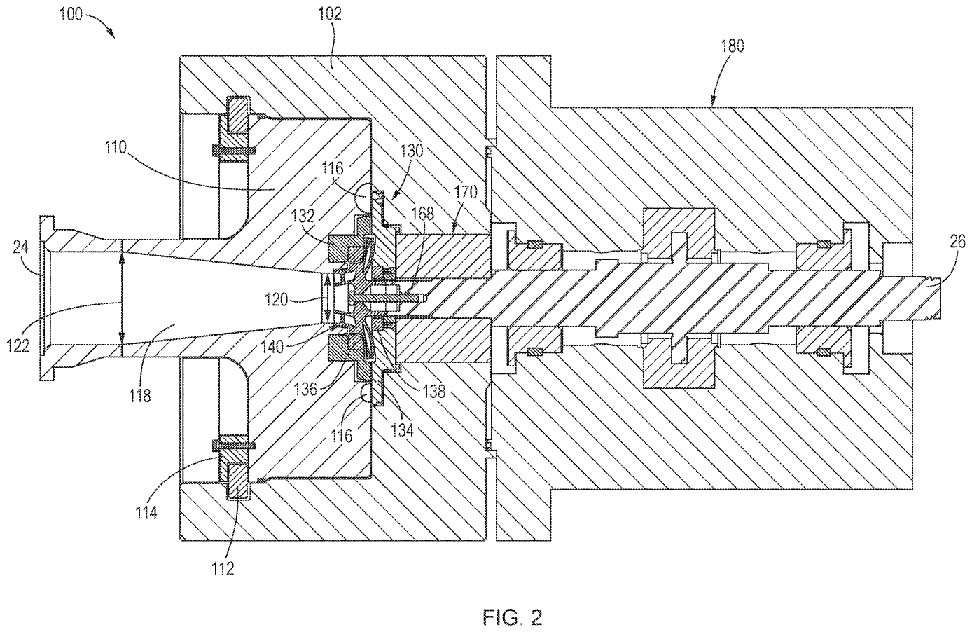

FIG. 2 schematically illustrates a cross-sectional view of a turbine 100 that may be used as the turbine 20 in the power system 10. The turbine 100 includes a housing 102. An end cap 110 is coupled to the housing 102 by one or more fasteners 112, such as locking dogs, a c-ring, or the like. The one or more fasteners 112 are maintained in engagement with the housing 102 by a retainer 114, such as a locking ring.

The end cap 110 includes a volute 116 that directs fluids from the inlet 22 (FIG. 1) to an impeller 140 (described below). The end cap 110 includes a nozzle 118 that conveys fluids from the impeller 140 to the outlet 24. The nozzle 118 is tapered from a minimum inner diameter 120 proximal to the impeller 140 to a maximum inner diameter 122 proximal to the outlet 124.

In some embodiments, the end cap 110 is interchangeable with one or more other end caps 110 having differing configurations, referred to herein as “end cap configurations.” In an example, two end caps 110 of differing end cap configurations may differ in a geometry of the volute 116. In another example, two end caps 110 of differing end cap configurations may differ in an inner diameter of the nozzle 118, such as the size of the minimum inner diameter 120 or the size of the maximum inner diameter 122.

An impeller assembly 130 is disposed in the housing 102, and is coupled to the end plate 110. The impeller assembly 130 includes the impeller 140, which is disposed between a seal housing 132 and a plate 134. An eye seal 136 coupled to the seal housing forms a seal against the impeller 140. A hub seal 138 coupled to the plate 134 forms another seal against the impeller 140. The impeller 140 is coupled to the shaft 26 by a fastener 168, such as a bolt. The shaft 26 rotates with rotation of the impeller 140.

A seal section 170 disposed in the housing 102 provides one or more seals against the shaft 26. The shaft 26 extends through the seal section 170 and into a bearing section 180 that is coupled to the housing 102. The bearing section 180 supports the shaft against axial and radial loads.

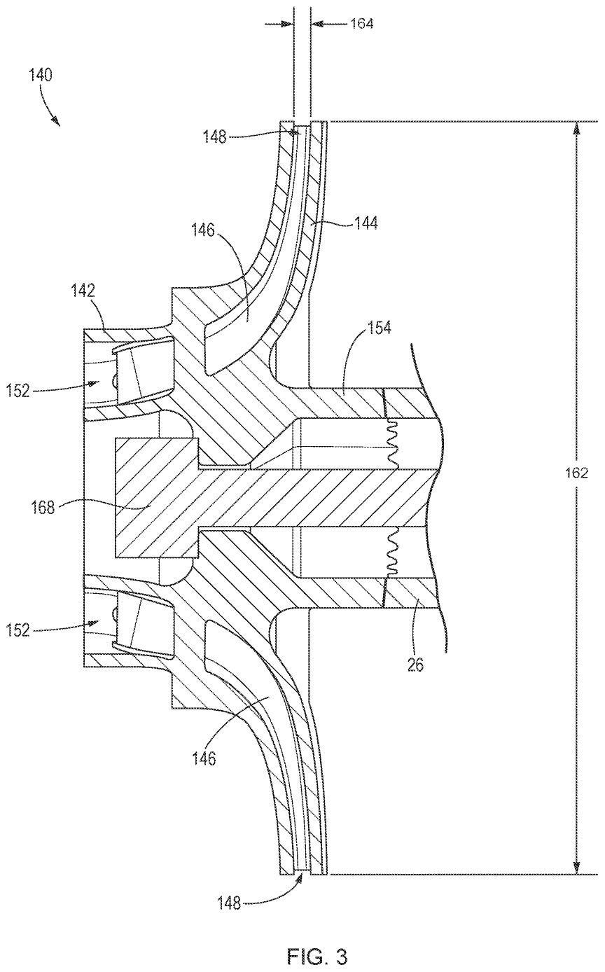

FIG. 3 schematically illustrates an enlarged cross-sectional view of the impeller 140. The impeller 140 includes a front shroud 142 and a rear shroud 144. One or more blades 146 are disposed between the front shroud 142 and the rear shroud 144. The front shroud 142, rear shroud 144, and the one or more blades 146 form curved fluid pathways from inlets 148 to corresponding outlets 152. A hub 154 extends from the rear shroud 144 opposite the outlets 152. The hub 154 couples with the shaft 26, and is rotationally locked thereto.

In some embodiments, the impeller 140 is interchangeable with one or more other impellers 140 having differing configurations, referred to herein as “impeller configurations.” In an example, two impellers 140 of differing impeller configurations may differ in a width 164 of each inlet 148. In another example, two impellers 140 of differing impeller configurations may differ in a maximum outer diameter 162 of the impellers 140.

In some embodiments, the impeller assembly 130 is interchangeable with one or more other impeller assemblies 130, each impeller assembly 130 including an impeller 140 of a differing impeller configuration, as described above.

The differing end cap configurations of end cap 110 and differing impeller configurations of impeller 140 may be tailored for use with different fluids having different compositions. In an example including four combinations of end cap 110 and impeller 140, a first end cap 110 has a first end cap configuration, and a second end cap 110 has a second end cap configuration different from the first end cap configuration. A first impeller 140 has a first impeller configuration, and a second impeller 140 has a second impeller configuration different from the first impeller configuration. The first end cap 110 used in combination with the first impeller 140 may be tailored for use with a first fluid. The second end cap 110 used in combination with the first impeller 140 may be tailored for use with a second fluid having a different composition to the first fluid. The first end cap 110 used in combination with the second impeller 140 may be tailored for use with a third fluid having a different composition to the first and second fluids. The second end cap 110 used in combination with the second impeller 140 may be tailored for use with a fourth fluid having a different composition to the first, second, and third fluids.

Operating parameters of the turbine 100 include fluid pressure, fluid temperature, fluid flow rate, and rotational speed of the shaft 26. In an example, the operating parameters include a ratio of a fluid pressure at the inlet 22 divided by a fluid pressure at the outlet 24, referred to as a pressure ratio. In some embodiments, the turbine 100 is operated to achieve a target pressure ratio. In some embodiments, the target pressure ratio is defined by an operating window. In some embodiments, the target pressure ratio includes a minimum threshold value.

In some embodiments, the operating parameters of the turbine 100 change due to thermal decline of a geothermal resource, such as subterranean formation 42. In some embodiments, the operating parameters of the turbine 100 change due to ambient temperature changes, such as through variations over a 24 hour period (day/night) or through seasonal variations (such as between summer and winter, etc.).

In some embodiments, when one or more operating parameters of the turbine 100 change (or are predicted to change) beyond a threshold value or target operating window, a remedial action may be taken. In an example, the remedial action includes changing the fluid that flows through the turbine 100 to a fluid of a different composition, while retaining the same impeller 140 and end cap 110 of the turbine 100. In another example, the remedial action incudes changing the impeller 140 of the turbine 100 to an impeller 140 of a differing impeller configuration (such as described above), while retaining the same fluid to operate the turbine 100. In another example, the remedial action incudes changing the end cap 110 of the turbine 100 to an end cap 110 of a differing end cap configuration (such as described above), while retaining the same fluid to operate the turbine 100. In some examples, the remedial action includes more than one of changing the fluid, changing the impeller, or changing the end cap.

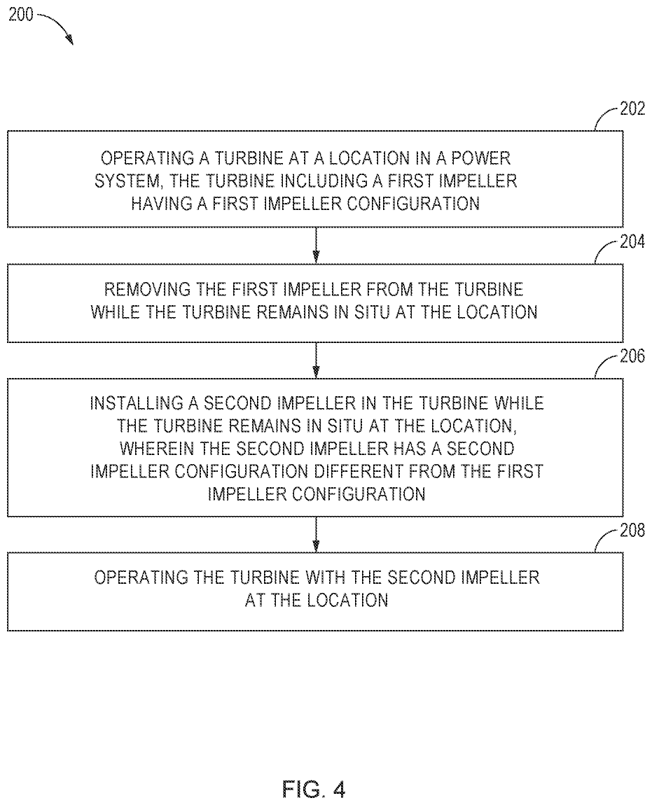

FIG. 4 is a flow diagram of a method 200 of operating a power system. In some embodiments, the power system is the power system 10. The power system includes a turbine, such as the turbine 20. In some embodiments, the turbine is configured similarly to the turbine 100.

Operation 202 includes operating a turbine at a location in a power system, the turbine including a first impeller (such as impeller 140) having a first impeller configuration. In some embodiments, operation 202 includes flowing a first fluid through the turbine such that the turbine drives a generator (such as generator 30) to generate electricity. The first fluid has a first composition. In some embodiments, the first fluid is a power fluid, such as power fluid 12. In some embodiments, the first fluid is a working fluid of the power system, such as described above. In some embodiments, the first fluid includes one of water, steam, brine, a refrigerant, a supercritical fluid, carbon dioxide, ammonia, an organic compound (e.g., a hydrocarbon, a fluorocarbon, etc.), or any combination thereof.

Operation 204 includes removing the first impeller from the turbine while the turbine remains in situ at the location. In some embodiments, operation 204 includes removing the first impeller from a housing of the turbine (such as housing 102). In some embodiments, operation 204 includes maintaining the housing at the location where operation 202 had been performed. In some embodiments, operation 204 includes maintaining a shaft (such as shaft 26) installed in the housing. In some embodiments, operation 204 includes maintaining the shaft installed in the housing and coupled to the generator. In some embodiments, operation 204 includes maintaining the shaft installed in the housing and coupled to a gearbox (such as gearbox 28).

Operation 206 includes installing a second impeller in the turbine while the turbine remains in situ at the location. In some embodiments, the second impeller has a second impeller configuration different from the first impeller configuration. In some embodiments, the second impeller configuration differs from the first impeller configuration in a width of an impeller inlet (such as inlet 148). In some embodiments, the second impeller configuration differs from the first impeller configuration in an impeller maximum outer diameter (such as maximum outer diameter 162).

In some embodiments, operation 206 is performed in response to determining a change in temperature of fluid at an inlet of the turbine. In some embodiments, determining a change in temperature of fluid at an inlet of the turbine includes measuring the temperature of fluid at an inlet of the turbine. In some embodiments, determining a change in temperature of fluid at an inlet of the turbine includes measuring the temperature of fluid at a location upstream of the turbine. In some embodiments, determining a change in temperature of fluid at an inlet of the turbine includes predicting the change in temperature by modeling.

In some embodiments, operation 206 is performed in response to determining a change in a ratio defined by an inlet fluid pressure at the turbine divided by an outlet fluid pressure at the turbine while operating the turbine with the first impeller. In some embodiments, determining a change in the ratio includes predicting the change in the ratio by modeling.

In some embodiments, operation 206 is performed in response to determining a change in ambient temperature at the turbine. In an example, the determining a change in ambient temperature is performed by measuring the ambient temperature. In another example, the determining a change in ambient temperature is performed by predicting the change in ambient temperature. In another example, the determining a change in ambient temperature corresponds to a transition between day time and night time. In another example, the determining a change in ambient temperature corresponds to a transition in weather, such as a prolonged duration of unseasonal heat or coldness. In another example, the determining a change in ambient temperature corresponds to a seasonal transition.

Operation 208 includes operating the turbine with the second impeller at the location. The location for operation 208 is the same location where operation 202 had been performed. In some embodiments, operation 208 includes flowing the first fluid through the turbine such that the turbine drives the generator to generate electricity. In some embodiments, operation 208 includes flowing a second fluid through the turbine such that the turbine drives the generator to generate electricity. The second fluid has a second composition different from the first composition. In some embodiments, the second fluid is a power fluid, such as power fluid 12. In some embodiments, the second fluid is a working fluid of the power system, such as described above. In some embodiments, the second fluid includes one of water, steam, brine, a refrigerant, a supercritical fluid, carbon dioxide, ammonia, an organic compound (e.g., a hydrocarbon, a fluorocarbon, etc.), or any combination thereof.

In some embodiments, method 200 includes removing a first end cap (such as end cap 110) having a first end cap configuration from the turbine while the turbine remains in situ at the location prior to removing the first impeller from the turbine. In some embodiments, method 200 includes installing a second end cap having a second end cap configuration onto the turbine while the turbine remains in situ at the location after installing the second impeller in the turbine. In some embodiments, the second end cap configuration differs from the first end cap configuration in a geometry of a volute (such as volute 116). In some embodiments, the second end cap configuration differs from the first end cap configuration in an inner diameter of a nozzle (such as nozzle 118).

In some embodiments, removing the first end cap and installing the second end cap are performed in response to determining a change in temperature of fluid at an inlet of the turbine, such as described above. In some embodiments, removing the first end cap and installing the second end cap are performed in response to determining a change in a ratio defined by an inlet fluid pressure at the turbine divided by an outlet fluid pressure at the turbine while operating the turbine with the first impeller, such as described above. In some embodiments, removing the first end cap and installing the second end cap are performed in response to determining a change in ambient temperature at the turbine, such as described above.

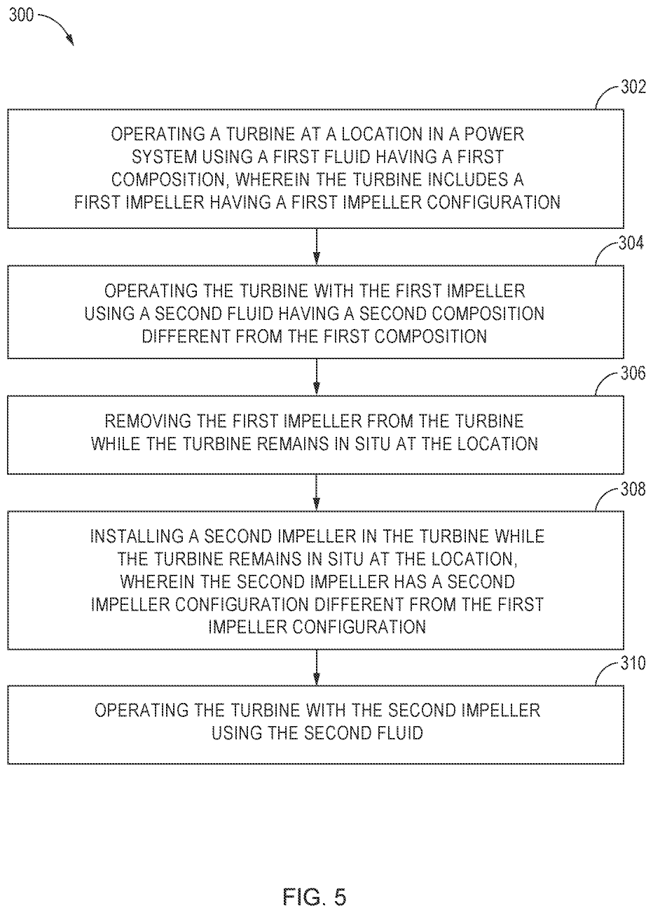

FIG. 5 is a flow diagram of a method 300 of operating a power system. In some embodiments, the power system is the power system 10. The power system includes a turbine, such as the turbine 20. In some embodiments, the turbine is configured similarly to the turbine 100.

Operation 302 includes operating a turbine at a location in a power system using a first fluid having a first composition. In some embodiments, the first fluid is a power fluid, such as power fluid 12. In some embodiments, the first fluid is a working fluid of the power system, such as described above. In some embodiments, the first fluid includes one of water, steam, brine, a refrigerant, a supercritical fluid, carbon dioxide, ammonia, an organic compound (e.g., a hydrocarbon, a fluorocarbon, etc.), or any combination thereof. The turbine includes a first impeller (such as impeller 140) having a first impeller configuration.

In some embodiments, operation 302 includes flowing the first fluid through the turbine such that the turbine drives a generator (such as generator 30) to generate electricity.

Operation 304 includes operating the turbine with the first impeller using a second fluid having a second composition different from the first composition. In some embodiments, the second fluid is a power fluid, such as power fluid 12. In some embodiments, the second fluid is a working fluid of the power system, such as described above. In some embodiments, the second fluid includes one of water, steam, brine, a refrigerant, a supercritical fluid, carbon dioxide, ammonia, an organic compound (e.g., a hydrocarbon, a fluorocarbon, etc.), or any combination thereof.

In some embodiments, operation 304 includes flowing the second fluid through the turbine such that the turbine drives a generator (such as generator 30) to generate electricity. In some embodiments, operation 304 is performed at the location where operation 302 had been performed. In some embodiments, operation 304 is performed in response to determining a change in temperature of the first fluid at an inlet of the turbine. In some embodiments, determining a change in temperature of the first fluid at an inlet of the turbine includes measuring the temperature of the first fluid at an inlet of the turbine. In some embodiments, determining a change in temperature of the first fluid at an inlet of the turbine includes measuring the temperature of the first fluid at a location upstream of the turbine. In some embodiments, determining a change in temperature of the first fluid at an inlet of the turbine includes predicting the change in temperature by modeling.

In some embodiments, operation 304 is performed in response to determining a change in a ratio defined by an inlet fluid pressure at the turbine divided by an outlet fluid pressure at the turbine while operating the turbine with the first impeller using the first fluid. In some embodiments, determining a change in the ratio includes predicting the change in the ratio by modeling.

In some embodiments, operation 304 is performed in response to determining a change in ambient temperature at the turbine. In an example, the determining a change in ambient temperature is performed by measuring the ambient temperature. In another example, the determining a change in ambient temperature is performed by predicting the change in ambient temperature. In another example, the determining a change in ambient temperature corresponds to a transition between day time and night time. In another example, the determining a change in ambient temperature corresponds to a transition in weather, such as a prolonged duration of unseasonal heat or coldness. In another example, the determining a change in ambient temperature corresponds to a seasonal transition.

Operation 306 includes removing the first impeller from the turbine while the turbine remains in situ at the location. In some embodiments, operation 306 includes removing the first impeller from a housing of the turbine (such as housing 102). In some embodiments, operation 306 includes maintaining the housing at the location where operation 302 had been performed. In some embodiments, operation 306 includes maintaining a shaft (such as shaft 26) installed in the housing. In some embodiments, operation 306 includes maintaining the shaft installed in the housing and coupled to the generator. In some embodiments, operation 306 includes maintaining the shaft installed in the housing and coupled to a gearbox (such as gearbox 28).

Operation 308 includes installing a second impeller in the turbine while the turbine remains in situ at the location. In some embodiments, the second impeller has a second impeller configuration different from the first impeller configuration. In some embodiments, the second impeller configuration differs from the first impeller configuration in a width of an impeller inlet (such as inlet 148). In some embodiments, the second impeller configuration differs from the first impeller configuration in an impeller maximum outer diameter (such as maximum outer diameter 162).

In some embodiments, operation 308 is performed in response to determining a change in temperature of the second fluid at an inlet of the turbine. In some embodiments, determining a change in temperature of the second fluid at an inlet of the turbine includes measuring the temperature of the second fluid at an inlet of the turbine. In some embodiments, determining a change in temperature of the second fluid at an inlet of the turbine includes measuring the temperature of the second fluid at a location upstream of the turbine. In some embodiments, determining a change in temperature of the second fluid at an inlet of the turbine includes predicting the change in temperature by modeling.

In some embodiments, operation 308 is performed in response to determining a change in a ratio defined by an inlet fluid pressure at the turbine divided by an outlet fluid pressure at the turbine while operating the turbine with the first impeller using the second fluid. In some embodiments, determining a change in the ratio includes predicting the change in the ratio by modeling.

In some embodiments, operation 308 is performed in response to determining a change in ambient temperature at the turbine. In an example, the determining a change in ambient temperature is performed by measuring the ambient temperature. In another example, the determining a change in ambient temperature is performed by predicting the change in ambient temperature. In another example, the determining a change in ambient temperature corresponds to a transition between day time and night time. In another example, the determining a change in ambient temperature corresponds to a transition in weather, such as a prolonged duration of unseasonal heat or coldness. In another example, the determining a change in ambient temperature corresponds to a seasonal transition.

Operation 310 includes operating the turbine with the second impeller using the second fluid. In some embodiments, operation 310 includes flowing the second fluid through the turbine such that the turbine drives a generator (such as generator 30) to generate electricity. In some embodiments, operation 310 is performed at the location where operation 302 had been performed.

In some embodiments, method 300 includes removing a first end cap (such as end cap 110) having a first end cap configuration from the turbine while the turbine remains in situ at the location prior to removing the first impeller from the turbine. In some embodiments, method 300 includes installing a second end cap having a second end cap configuration onto the turbine while the turbine remains in situ at the location after installing the second impeller in the turbine. In some embodiments, the second end cap configuration differs from the first end cap configuration in a geometry of a volute (such as volute 116). In some embodiments, the second end cap configuration differs from the first end cap configuration in an inner diameter of a nozzle (such as nozzle 118).

In some embodiments, removing the first end cap and installing the second end cap are performed in response to determining a change in temperature of the second fluid at an inlet of the turbine, such as described above. In some embodiments, removing the first end cap and installing the second end cap are performed in response to determining a change in a ratio defined by an inlet fluid pressure at the turbine divided by an outlet fluid pressure at the turbine while operating the turbine with the first impeller using the second fluid, such as described above. In some embodiments, removing the first end cap and installing the second end cap are performed in response to determining a change in ambient temperature at the turbine, such as described above.

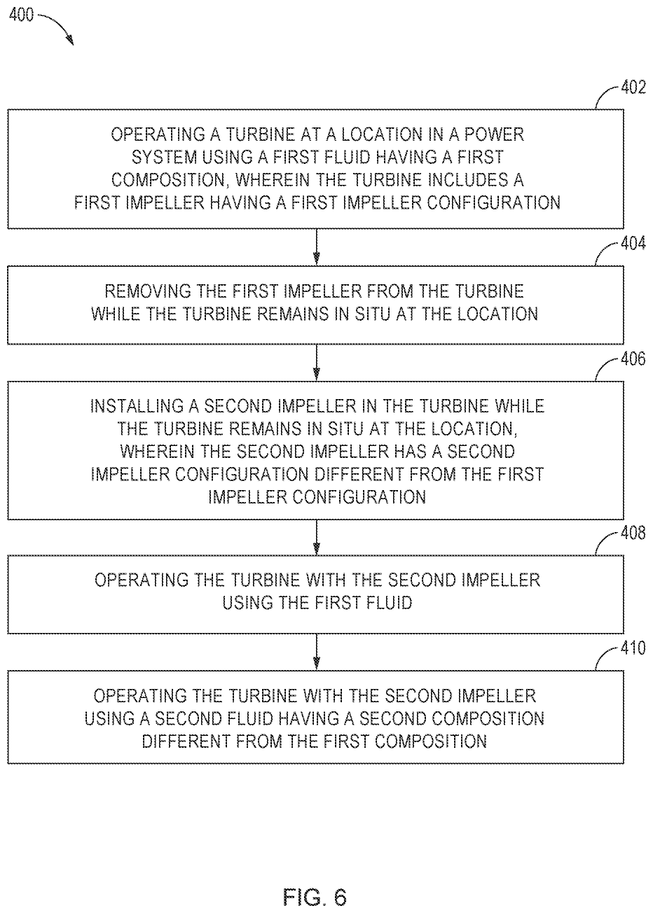

FIG. 6 is a flow diagram of a method 400 of operating a power system. In some embodiments, the power system is the power system 10. The power system includes a turbine, such as the turbine 20. In some embodiments, the turbine is configured similarly to the turbine 100.

Operation 402 includes operating a turbine at a location in a power system using a first fluid having a first composition. In some embodiments, the first fluid is a power fluid, such as power fluid 12. In some embodiments, the first fluid is a working fluid of the power system, such as described above. In some embodiments, the first fluid includes one of water, steam, brine, a refrigerant, a supercritical fluid, carbon dioxide, ammonia, an organic compound (e.g., a hydrocarbon, a fluorocarbon, etc.), or any combination thereof. The turbine includes a first impeller (such as impeller 140) having a first impeller configuration.

In some embodiments, operation 402 includes flowing the first fluid through the turbine such that the turbine drives a generator (such as generator 30) to generate electricity.

Operation 404 includes removing the first impeller from the turbine while the turbine remains in situ at the location. In some embodiments, operation 404 includes removing the first impeller from a housing of the turbine (such as housing 102). In some embodiments, operation 404 includes maintaining the housing at the location where operation 402 had been performed. In some embodiments, operation 404 includes maintaining a shaft (such as shaft 26) installed in the housing. In some embodiments, operation 404 includes maintaining the shaft installed in the housing and coupled to the generator. In some embodiments, operation 404 includes maintaining the shaft installed in the housing and coupled to a gearbox (such as gearbox 28).

Operation 406 includes installing a second impeller in the turbine while the turbine remains in situ at the location. In some embodiments, the second impeller has a second impeller configuration different from the first impeller configuration. In some embodiments, the second impeller configuration differs from the first impeller configuration in a width of an impeller inlet (such as inlet 148). In some embodiments, the second impeller configuration differs from the first impeller configuration in an impeller maximum outer diameter (such as maximum outer diameter 162).

In some embodiments, operation 406 is performed in response to determining a change in temperature of the first fluid at an inlet of the turbine. In some embodiments, determining a change in temperature of the first fluid at an inlet of the turbine includes measuring the temperature of the first fluid at an inlet of the turbine. In some embodiments, determining a change in temperature of the first fluid at an inlet of the turbine includes measuring the temperature of the first fluid at a location upstream of the turbine. In some embodiments, determining a change in temperature of the first fluid at an inlet of the turbine includes predicting the change in temperature by modeling.

In some embodiments, operation 406 is performed in response to determining a change in a ratio defined by an inlet fluid pressure at the turbine divided by an outlet fluid pressure at the turbine while operating the turbine with the first impeller using the first fluid. In some embodiments, determining a change in the ratio includes predicting the change in the ratio by modeling.

In some embodiments, operation 406 is performed in response to determining a change in ambient temperature at the turbine. In an example, the determining a change in ambient temperature is performed by measuring the ambient temperature. In another example, the determining a change in ambient temperature is performed by predicting the change in ambient temperature. In another example, the determining a change in ambient temperature corresponds to a transition between day time and night time. In another example, the determining a change in ambient temperature corresponds to a transition in weather, such as a prolonged duration of unseasonal heat or coldness. In another example, the determining a change in ambient temperature corresponds to a seasonal transition.

Operation 408 includes operating the turbine with the second impeller using the first fluid. In some embodiments, operation 408 includes flowing the first fluid through the turbine such that the turbine drives a generator (such as generator 30) to generate electricity. In some embodiments, operation 408 is performed at the location where operation 402 had been performed.

Operation 410 includes operating the turbine with the second impeller using a second fluid having a second composition different from the first composition. In some embodiments, the second fluid is a power fluid, such as power fluid 12. In some embodiments, the second fluid is a working fluid of the power system, such as described above. In some embodiments, the second fluid includes one of water, steam, brine, a refrigerant, a supercritical fluid, carbon dioxide, ammonia, an organic compound (e.g., a hydrocarbon, a fluorocarbon, etc.), or any combination thereof.

In some embodiments, operation 410 includes flowing the second fluid through the turbine such that the turbine drives a generator (such as generator 30) to generate electricity. In some embodiments, operation 410 is performed at the location where operation 402 had been performed.

In some embodiments, operation 410 is performed in response to determining a change in temperature of the first fluid at an inlet of the turbine. In some embodiments, determining a change in temperature of the first fluid at an inlet of the turbine includes measuring the temperature of the first fluid at an inlet of the turbine. In some embodiments, determining a change in temperature of the first fluid at an inlet of the turbine includes measuring the temperature of the first fluid at a location upstream of the turbine. In some embodiments, determining a change in temperature of the first fluid at an inlet of the turbine includes predicting the change in temperature by modeling.

In some embodiments, operation 410 is performed in response to determining a change in a ratio defined by an inlet fluid pressure at the turbine divided by an outlet fluid pressure at the turbine while operating the turbine with the first impeller using the first fluid. In some embodiments, determining a change in the ratio includes predicting the change in the ratio by modeling.

In some embodiments, operation 410 is performed in response to determining a change in ambient temperature at the turbine. In an example, the determining a change in ambient temperature is performed by measuring the ambient temperature. In another example, the determining a change in ambient temperature is performed by predicting the change in ambient temperature. In another example, the determining a change in ambient temperature corresponds to a transition between day time and night time. In another example, the determining a change in ambient temperature corresponds to a transition in weather, such as a prolonged duration of unseasonal heat or coldness. In another example, the determining a change in ambient temperature corresponds to a seasonal transition.

In some embodiments, method 400 includes removing a first end cap (such as end cap 110) having a first end cap configuration from the turbine while the turbine remains in situ at the location prior to removing the first impeller from the turbine. In some embodiments, method 400 includes installing a second end cap having a second end cap configuration onto the turbine while the turbine remains in situ at the location after installing the second impeller in the turbine. In some embodiments, the second end cap configuration differs from the first end cap configuration in a geometry of a volute (such as volute 116). In some embodiments, the second end cap configuration differs from the first end cap configuration in an inner diameter of a nozzle (such as nozzle 118).

In some embodiments, removing the first end cap and installing the second end cap are performed in response to determining a change in temperature of the first fluid at an inlet of the turbine, such as described above. In some embodiments, removing the first end cap and installing the second end cap are performed in response to determining a change in a ratio defined by an inlet fluid pressure at the turbine divided by an outlet fluid pressure at the turbine while operating the turbine with the first impeller using the first fluid, such as described above. In some embodiments, removing the first end cap and installing the second end cap are performed in response to determining a change in ambient temperature at the turbine, such as described above.

Any of method 200, method 300, or method 400 may include any non-mutually exclusive aspect, activity, or operation described herein.

It is contemplated that changing the impeller or the end cap of the turbine while the turbine remains in situ at the location in the power system at which the turbine is operated may be accomplished faster than removing the turbine to a workshop or repair facility to perform such operations. In an example, removing the turbine from the location, then changing the impeller or the end cap, then replacing the turbine at the location may take a few hours, such as two or three hours. In contrast, changing the impeller or the end cap of the turbine while the turbine remains in situ at the location in the power system at which the turbine is operated may take less than one hour, such as 45 minutes or less, or 30 minutes.

Aspects of the present disclosure provide benefits of efficiency and reduced downtime compared to conventional systems when changing components of a turbine to suit changing operating conditions of a power system.

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A method comprising:
operating a turbine at a location in a power system, the turbine including a first impeller having a first impeller configuration;
removing the first impeller from the turbine while the turbine remains in situ at the location;
installing a second impeller in the turbine while the turbine remains in situ at the location, wherein the second impeller has a second impeller configuration different from the first impeller configuration; and
operating the turbine with the second impeller at the location.

2. The method of claim 1, wherein operating the turbine including the first impeller comprises flowing a first fluid through the turbine such that the turbine drives a generator to generate electricity, the first fluid having a first composition.

3. The method of claim 2, wherein operating the turbine with the second impeller comprises flowing one of the first fluid or a second fluid through the turbine such that the turbine drives the generator to generate electricity, the second fluid having a second composition different from the first composition.

4. The method of claim 3, wherein each of the first fluid and the second fluid includes at least one of water, steam, brine, a refrigerant, a supercritical fluid, carbon dioxide, ammonia, an organic compound, or any combination thereof.

5. The method of claim 3, wherein the installing of the second impeller in the turbine is performed in response to determining a change in temperature at an inlet of the turbine of the first fluid or the second fluid.

6. The method of claim 1, further comprising:
removing a first end cap having a first end cap configuration from the turbine while the turbine remains in situ at the location prior to removing the first impeller from the turbine; and
installing a second end cap having a second end cap configuration onto the turbine while the turbine remains in situ at the location after installing the second impeller in the turbine.

7. A method comprising:
operating a turbine at a location in a power system using a first fluid having a first composition, wherein the turbine includes a first impeller having a first impeller configuration;
operating the turbine with the first impeller using a second fluid having a second composition different from the first composition;
removing the first impeller from the turbine while the turbine remains in situ at the location;
installing a second impeller in the turbine while the turbine remains in situ at the location, wherein the second impeller has a second impeller configuration different from the first impeller configuration; and
operating the turbine with the second impeller using the second fluid.

8. The method of claim 7, wherein operating the turbine with the first impeller using the second fluid is in response to determining a change in temperature of the first fluid at an inlet of the turbine.

9. The method of claim 7, wherein operating the turbine with the first impeller using the second fluid is in response to determining a change in ambient temperature at the turbine.

10. The method of claim 7, wherein the installing of the second impeller in the turbine is performed in response to determining a change in temperature of the second fluid at an inlet of the turbine.

11. The method of claim 7, wherein the installing of the second impeller in the turbine is performed in response to determining a change of a ratio defined by an inlet fluid pressure at the turbine divided by an outlet fluid pressure at the turbine while operating the turbine with the first impeller using the second fluid.

12. The method of claim 7, further comprising:
removing a first end cap from the turbine while the turbine remains in situ at the location prior to removing the first impeller from the turbine, the first end cap having a first end cap configuration; and
installing a second end cap onto the turbine while the turbine remains in situ at the location after installing the second impeller in the turbine, the second end cap having a second end cap configuration different from the first end cap configuration.

13. The method of claim 7, wherein each of the first fluid and the second fluid includes at least one of water, steam, brine, a refrigerant, a supercritical fluid, carbon dioxide, ammonia, an organic compound, or any combination thereof.

14. A method comprising:
operating a turbine at a location in a power system using a first fluid having a first composition, wherein the turbine includes a first impeller having a first impeller configuration;
removing the first impeller from the turbine while the turbine remains in situ at the location;
installing a second impeller in the turbine while the turbine remains in situ at the location, wherein the second impeller has a second impeller configuration different from the first impeller configuration;
operating the turbine with the second impeller using the first fluid; and
operating the turbine with the second impeller using a second fluid having a second composition different from the first composition.

15. The method of claim 14, wherein the installing of the second impeller in the turbine is in response to determining a change in temperature of the first fluid at an inlet of the turbine.

16. The method of claim 15, wherein operating the turbine with the second impeller using the second fluid is performed in response to determining a further change in temperature of the first fluid at the inlet of the turbine.

17. The method of claim 14, wherein the installing of the second impeller in the turbine is performed in response to determining a change of a ratio defined by an inlet fluid pressure at the turbine divided by an outlet fluid pressure at the turbine while operating the turbine with the first impeller using the first fluid.

18. The method of claim 14, wherein operating the turbine with the second impeller using the second fluid is in response to determining a change in ambient temperature at the turbine.

19. The method of claim 14, further comprising:
removing a first end cap from the turbine while the turbine remains in situ at the location prior to removing the first impeller from the turbine, the first end cap having a first end cap configuration; and
installing a second end cap onto the turbine while the turbine remains in situ at the location after installing the second impeller in the turbine, the second end cap having a second end cap configuration different from the first end cap configuration.

20. The method of claim 14, wherein each of the first fluid and the second fluid includes at least one of water, steam, brine, a refrigerant, a supercritical fluid, carbon dioxide, ammonia, an organic compound, or any combination thereof.
